(19) United States
(12) Patent Application Publication
(10) Pub. No.: US 2011/0271859 A1
(43) Pub. Date: Nov. 10, 2011

(54) THERMOSENSITIVE IMAGING COMPOSITION AND LITHOGRAPHIC PLATE COMPRISING THE SAME

(76) Inventors: Shiyou Li, Sichuan (CN); Hongwei Yuan, Sichuan (CN)

(21) Appl. No.: 13/142,213

(22) PCT Filed: Dec. 24, 2009
(86) PCT No.: PCT/CN2009/075941

§ 371 Date: Jun. 24, 2011

(30) Foreign Application Priority Data
Dec. 24, 2008 (CN) 200810147999.7

(51) Int. Cl. B41N 1/08

(52) U.S. Cl. 101/457

(57) ABSTRACT

The present application relates to a positive-working heat-sensitive lithographic plate. The infrared heat-sensitive image recording composition of the plate comprises a resin having self-dissolution inhibiting property and an infrared absorber. The resin having self-dissolution inhibiting property is an alkali-soluble resin that contains phenolic hydroxyl group, and carbamate or thiocarbamate group that has strong electron-absorbing ability. The advantage of the present application is that it requires no dissolution inhibitor when preparing the infrared positive-working heat-sensitive CTP plate. The mechanism could be understood but not limited to that the carbamate or thiocarbamate group contained in the resin has a dissolution inhibiting effect on the phenolic hydroxyl group in the resin, reducing the solubility of the resin in an alkali solution. When the plate is irradiated by an infrared laser, the infrared radiation transformed into heat, and since the above dissolution inhibiting effect would be impaired under high temperature, the solubility of the resin in an alkali solution can be restored.

### FIELD OF THE INVENTION

The present application relates to an infrared positive-working thermosensitive CTP (Computer-to-Print) lithographic plate and a thermosensitive image recording composition used to prepare said plate.

### BACKGROUND OF THE INVENTION

Photosensitive compositions have been widely employed in areas such as printed circuit board (PCB) and lithographic printing plate. Typically, these compositions are coated as a layer onto a substrate, dried and/or cured, forming an imageable element (a thin film), and then imagewise irradiated with suitable radiation or particle beams. Subsequent to irradiation, the irradiated areas could have different properties with those of the unirradiated areas. In some cases the imagewise irradiation directly causes the irradiated areas to be physically removed or ablated. In other cases the behavior of the irradiated area is chemically changed by the irradiation process, one example being that the irradiated area could become more or less soluble in a suitable liquid than the unirradiated area, another example being that the irradiated area changes its affinity for some liquids, such as ink, oil, water or fountain solution, as compared with the unirradiated areas.

Lithographic printing is the most commonly used form of printing today, and it involves creating printing and non-printing areas on a suitable planar surface. Lithographic printing process is printing from specially prepared planar surfaces, some areas of which are capable of accepting lithographic ink or oil, whereas other areas, when moistened with water, will not accept the ink or oil. The areas which accept ink or oil form the printing image areas and the areas which reject the ink or oil form the background areas. Printing and non-printing areas could be arranged into images and background with imagewise irradiation. These images and background have different affinities for printing ink, and water or fountain solution. When the unirradiated areas of the film ultimately form the printing images, the lithographic printing plate is referred to as “positive working”. Conversely, when the irradiated areas of the film ultimately form the printing images, the plate is referred to as “negative working”.

In a conventional process for producing lithographic printing plate or printed circuit board, a film with original image is placed on a photo sensitive layer. The layer is then irradiated with ultraviolet and/or visible light through the film. Such method is cumbersome and labor intensive. In recent ten years, laser direct imaging methods (LDI) have been widely developed and applied for producing lithographic printing plate or printed circuit board on the basis of digital data from a computer directly being transferred onto the lithographic printing plate or printed circuit board without requiring the intermediate processing of a photographic film. LDI offers many advantages such as line quality, just-in-time processing, improved manufacturing yields, elimination of film costs, and other recognized benefits.

The photosensitive layer of a conventional PS positive working plate contains O-quinonediazide compound and an alkali-soluble resin. The solubility of the alkali-soluble resin in an alkali developer is suppressed by the presence of the O-quinonediazide compound. By the irradiation of ultraviolet light, the O-quinonediazide compound will be photochemically decomposed to form indenecarboxylic acid, whereby the above solubility-suppressing effect will be lost, and the solubility of the above photosensitive layer in the alkali developer will be greatly improved. Namely, the image-forming mechanisms of the photosensitive layer containing the O-quinonediazide compound and an alkali-soluble resin can be attributable to the difference in solubility as between the exposed portion and the non-exposed portion due to the solubility change as described above.

The photosensitive composition containing the O-quinonediazide compound and an alkali-soluble resin has been widely used for preparing positive-working lithographic printing plate. The plate was exposed with irradiation of ultraviolet light through a silver salt original masking film, followed by development in an aqueous alkali solution so as to form a positive image. However, the conventional PS positive working plate having a photosensitive layer containing the O-quinonediazide compound and an alkali-soluble resin has a drawback that it must be handled under yellow light, as it is sensitive to ultraviolet light. And, it has a problem of poor storage stability and a low resolution. The thermosensitive printing plate is gradually replacing the photosensitive printing plate.

JP-A-60-61 752 discloses an attempt to eliminate the need for an original image film and to obtain a printing plate directly from computer data. Since the photosensitive layer is not sensitive enough to the directly exposed laser, it was coated with a layer of a silver halide. The silver halide may then directly be exposed to the laser under the control of a computer. Subsequently, the silver halide layer is developed and a silver image is left on the photosensitive layer. The silver image serves as a mask during the exposure of the photosensitive layer. After the exposure, the silver image is removed and the photosensitive layer is developed. Such method has a disadvantage that a complex development and much developing liquids are needed.

Another attempt has been made, i.e., a metal layer or a layer containing carbon black is covered on a photosensitive layer. This metal layer or the layer containing carbon black is then ablated by a laser so that an image mask is obtained on the photosensitive layer. The photosensitive layer is then exposed by UV-light through the image mask. After removal of the image mask, the photosensitive layer is developed to obtain a printing plate. Such method is disclosed in for example GB-1 492 070, but still has a disadvantage that the image mask has to be removed prior to the development of the photosensitive layer.

U.S. Pat. No. 5,340,699 describes a negative working IR-laser recording imageable element. The IR-sensitive layer comprises a novolac resin, a latent Bronsted acid and an IR-absorbing substance. The printing result of a lithographic plate obtained by irradiating and developing said imageable element are reported as poor.

EP 784233 discloses a negative working chemical amplification type photosensitive composition comprising an alkali-soluble resin such as novolac resin or polyvinyl phenol, an amino compound capable of crosslinking the resin, an infrared light-absorbing agent having a specific structure and a photo-acid-generator. The performance of such technique is not suitable for actual use. For example, in case of a negative photosensitive material which requires a heat treatment after exposure, it is considered that an acid generated from the exposure acts as a catalyst, which facilitates the crosslinking reaction during the heat treatment to form a negative image. However, in such a case, the stability of the image quality was not satisfactory, due to the variation of the heat treatment conditions. On the other hand, in case of a positive photosensitive material which does not require such a heat treatment after exposure, the contrast between an exposed portion and a non-exposed portion was inadequate. Consequently, the non-image portion was not easily removed, or the image portion of the film was not sufficiently maintained. Further, the run-length was not necessarily adequate.

Positive-working direct laser lithographic printing plate based on phenolic resins sensitive to UV, visible and/or infrared radiation have been described in U.S. Pat. No. 4,708,925, U.S. Pat. No. 5,372,907, U.S. Pat. No. 5,491,046, U.S. Pat. No. 5,840,467, U.S. Pat. No. 5,962,192 and U.S. Pat. No. 6,037,085.

U.S. Pat. No. 4,708,925 discloses a photosensitive printing plate provided with a photosensitive layer containing phenolic resin and onium salt. The inherent solubility of the phenolic resin is restored upon photolytic decomposition of the onium salt. This composition may optionally contain an IR-sensitizer. After imagewise exposed to UV light, visible light and/or IR-radiation followed by a development step with an aqueous alkali liquid, a positive or negative working printing plate is obtained. The printing results of a lithographic plate obtained by irradiating and developing said imageable element are reported as poor.

U.S. Pat. No. 5,372,907 and U.S. Pat. No. 5,491,046 disclose a radiation-sensitive composition especially adapted to prepare a lithographic printing plate that is sensitive to both ultraviolet and infrared radiation and capable of functioning in either a positive-working or negative-working manner is comprised of a novolac resin, a latent Bronsted acid and an infrared absorber. The solubility of the composition in an aqueous alkali developing solution is reduced in exposed areas and increased in unexposed areas after imagewise exposure and preheating. The printing results of a lithographic plate obtained by irradiating and developing said imageable element are reported as poor.

In a new generation of positive working processed plates, polymers which have a tendency for hydrogen bonding, either with themselves or with other additives are favored. The formation of the hydrogen bonding can reduce the solubility of the polymer in an aqueous alkaline solution. When irradiated, the hydrogen bonding is broke and the polymer becomes, at least temporarily, more soluble in the developer. If possible, light-to-heat-converter substances may be added to change the absorbing wavelengths and additional inhibitor substances may be added to shift the baseline of the solution inhibition process.

U.S. Pat. No. 5,840,467 describes a positive working image recording material, which comprises a binder, a light-to-heat converter substance and a heat-decomposable substance capable of substantially lowering the solubility of the material. Specific examples of the heat-decomposable substance include diazonium salts and O-quinonediazides. Specific examples of the binder include phenolic, acrylic and polyurethane resins. Various pigments and dyes are given as potential light-to-heat converter substances, including specific cyanine dyes. In U.S. Pat. No. 5,962,192 and U.S. Pat. No. 6,037,085, thermo-laser-sensitive compositions are described based on azide-materials wherein a dye component is added to improve the sensitivity.

Significant weight loss is one major issue shared by most positive working processed plates. This weight loss is a result of the over-dissolution of unexposed areas in the developer when the plate is being processed. In order to reduce weight loss, the contrast between exposed and unexposed areas can be utilized to balance the developer strength and development time. Much of this phenomenon may be due to the fact that these plates fundamentally rely on the dissolution difference of the exposed and the unexposed areas in alkaline solutions.

Another major issue with positive working processed plates is their relatively weak chemical resistance. This behavior affects the compatibility of plates with some necessary chemicals and decreases their performance. In order to overcome this drawback, some methods such as the incorporation of suitable crosslinking agents and a post-heat treatment, and even an ultraviolet illumination treatment or other processes are used.

It is clear that there remains a need for positive working plates which do not require a pre-treatment or a post-treatment and have good durability. At the same time, the need remains for positive plates that have stronger chemical resistance and lower weight loss. Such needs depend on an improved photosensitive composition and imageable elements. In order to overcome the aforementioned drawbacks existing in the reported thermosensitive CTP plates, a chemically synthesized water-insoluble and alkali soluble resin which has a self dissolution inhibition property is disclosed herein, an infrared thermosensitive CTP image recording composition are prepared therefrom and a positive thermosensitive CTP plate are also obtained therefrom.

### SUMMARY OF THE INVENTION

The present application provides a thermosensitive image recording composition and a thermosensitive lithographic plate prepared therefrom.

### DETAILED DESCRIPTION OF THE PREFERRED EMBODIMENT

1. A positive-working thermosensitive lithographic printing plate, characterized in that it consists essentially of a hydrophilic substrate and a thermosensitive image recording composition and said composition comprises:

(A) a resin having a self-dissolution inhibiting ability; and
(B) an infrared absorber.

2. The printing plate according to item 1, wherein said resin is an alkali-soluble resin that contains phenolic hydroxyl group, and carbamate or thiocarbamate group that has strong electron-absorbing ability and the resin is shown as formulas I and II:

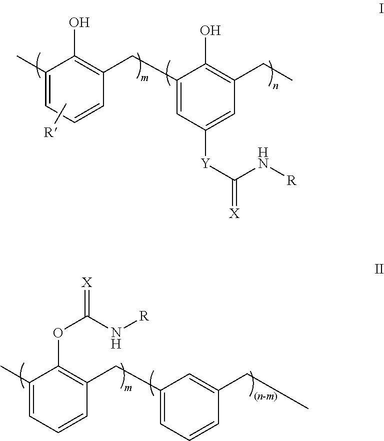

in which, X═O or S; Y═O or N; R=phenyl, p-tolyl, isopropyl, 1-naphthyl, o-tolyl, or cyclohexyl; R′=hydrogen or alkyl; in Formula I, m/(m+n)=0.05˜0.8; in Formula II, m/n=0.05˜0.7.

3. The printing plate according to item 1, wherein the infrared absorber absorbs infrared light with a wavelength between 750 nm and 1200 nm.

4. The printing plate according to item 1, wherein the infrared absorber is at least one selected from the group consisting of cyanine dye, anthraquinone dye, phthalocyanine dye, quinone imine dye, and methine dye.

5. The printing plate according to item 1, wherein the resin accounts for 55˜95 wt % of the total solid weight of the image recording composition.

6. The printing plate according to item 1, wherein the infrared absorber accounts for 1.0˜6 wt % of the total solid weight of the image recording composition.

7. The printing plate according to item 1, wherein the hydrophilic substrate is aluminum substrate.

I) A resin having a self dissolution inhibiting property is a water-insoluble and alkali-soluble resin that contains phenolic hydroxyl group, and carbamate or thiocarbamate group that has strong electron-absorbing ability and the resin is shown as formulas I and II.

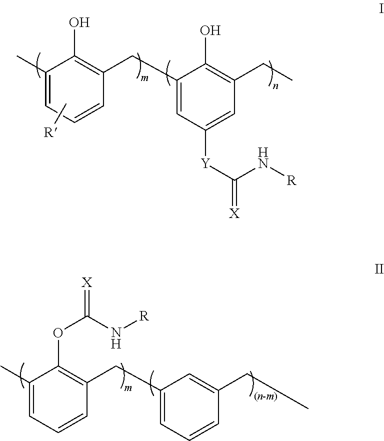

in which, X═O or S; Y═O or N; R=phenyl, p-tolyl; R′=hydrogen or alkyl.

II) A thermosensitive image recording composition.

III) A positive thermosensitive printing plate using the thermosensitive image recording composition, which requires no heat treatment after exposure.

IV) During the developing process after exposing the positive thermosensitive CTP plate, the exposed composition is completely dissolved in alkali developer. No sludge can be found in the processor tank.

The thermosensitive lithographic printing plate prepared with said thermosensitive image recording composition can substantially improve the chemical resistance, durability, sensitivity and development allowance.

The thermosensitive image recording composition of the invention comprises an alkali-soluble resin that contains phenolic hydroxyl group, and carbamate or thiocarbamate group, an infrared absorber. The composition may optionally comprise additives including surfactant, background coloring dye, solvent, etc. Firstly, obtained by chemical synthesis, an alkali-soluble resin contains phenolic hydroxyl group, and carbamate or thiocarbamate group that has strong electron-absorbing ability. Secondly, the thermosensitive image recording composition is prepared for plate making and performance testing. The detailed description of the composition is as follows.

### 1. Alkali-Soluble Resin

The resin used in this invention is an alkali-soluble resin that contains phenolic hydroxyl group, and carbamate or thiocarbamate group that has strong electron-absorbing ability. In the following formula, R—NCO is one selected from phenyl isocyanate, p-tolyl isocyanate, isopropyl isocyanate, 1-naphthyl isocyanate and other compounds containing isocyanate groups; R—NCS is one selected from phenyl isothiocyanate, p-tolyl isothiocyanate, 1-naphthyl isothiocyanate, o-tolyl isothiocyanate, cyclohexyl isothiocyanate, etc.; R is one selected from hydrogen, methyl, ethyl, propyl, butyl, tertbutyl, etc.

The synthesis of compounds containing phenolic hydroxyl group: Hydroquinone or p-aminophenol is reacted with isocyanates or isothiocyanates in trichloromethane or other solvents to obtain the following monomers A, B, C, D:

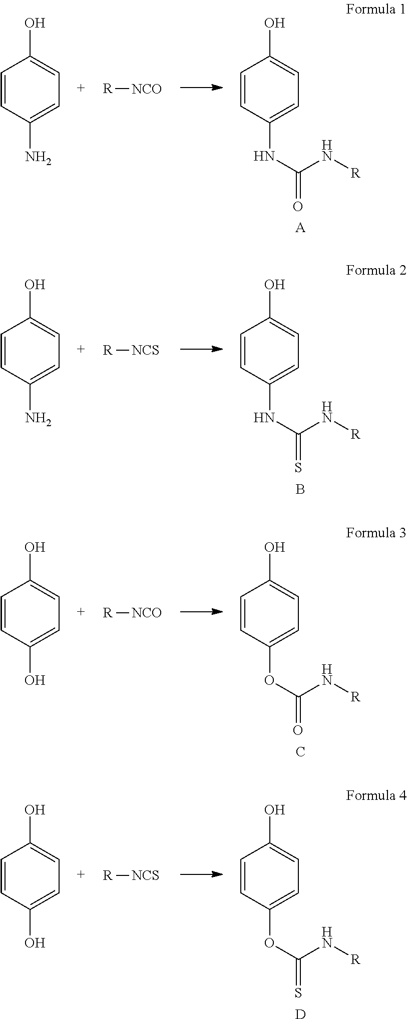

### Preparation of the Polymer

Polycondensation is respectively carried out between the aforementioned respective four monomers and phenolic derivatives and formaldehyde solution under an acid catalysis to obtain the following four kinds of alkali-soluble polymer that contains phenolic hydroxyl group, and carbamate or thiocarbamate group that has strong electron-absorbing ability. The molecular weight thereof is 3000˜10000.

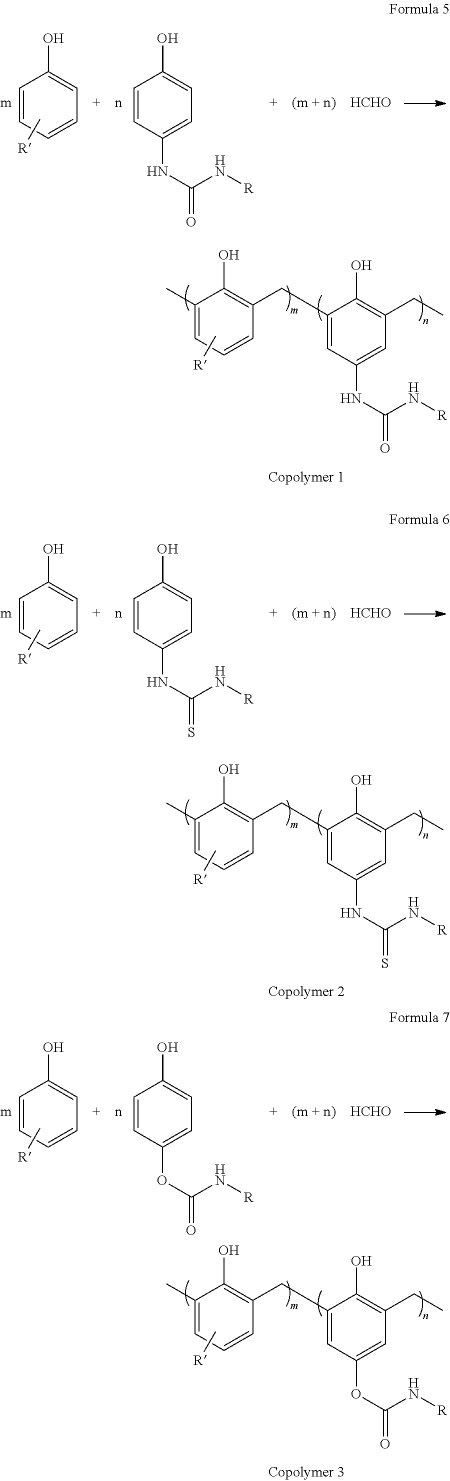

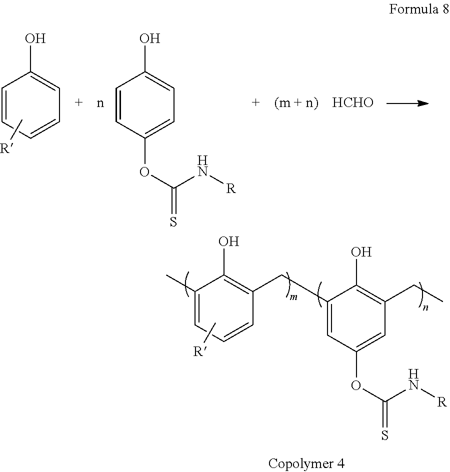

In addition, as for novolak phenolic resin with a molecular weight of 5000˜6000, its partial modified reaction is carried with isocyanate or isothiocyanate in acetone solvent to obtain the following polymers.

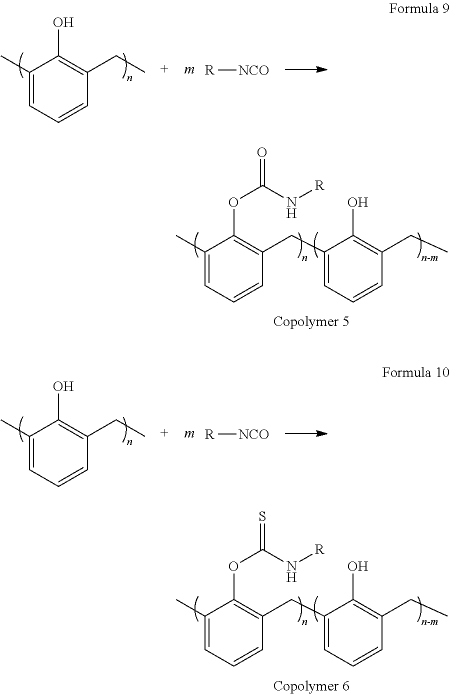

All of the aforementioned obtained polymers contain alkali-soluble phenolic hydroxyl group, and carbamate or thiocarbamate group that has strong electron-absorbing ability. Since the phenolic hydroxyl group is rich in electron and the carbamate or thiocarbamate group has strong electron absorbing ability, the phenolic hydroxyl group can easily form hydrogen bonds in or between molecules with carbamate or thiocarbamate group at room temperature so as to achieve an orderly arrangement, and subsequently its alkali-solubility in an alkaline developer is reduced. At infrared radiation area, infrared absorber absorbs infrared light and converts it into instant heat that results in a rise in temperature, causing the hydrogen bonds of phenolic hydroxyl group, and carbamate or thiocarbamate group in or between molecules to be broken, which result in a disordered arrangement of molecules and improving the solubility of the alkali-soluble resin containing phenolic hydroxyl group in an alkali solution. This can be determined by the dissolution time differences between irradiated and non-irraidated areas as shown in examples. In formula I, n/(m+n)=5˜80%, preferably 10˜35%; in formula II, m/n=5˜70%, preferably 5˜25%, the addition of water-insoluble, alkali-soluble copolymers accounts for 55˜95% of the total solid amount, preferably 75˜90%.

### 2. Infrared Absorber

Infrared absorber is also known as light-heat conversion material. It refers to any material capable of absorbing infrared or near-infrared and converting it into heat. It is required that a dye has a suitable solubility in coating solvent and absorbs the infrared in a wavelength range between 750 nm and 1200 nm. The simplest infrared absorber is carbon black, and some special dyes can also be used such as azo dyes, metal complex salt azo dyes, pyrroline ketone azo dye, anthraquinone dye, phthalocyanine dye, carbenium dye, quinone imino dye, methine dye, cyanine dye, etc.

The especially useful infrared absorber is shown as follows. The infrared absorber used in the positive thermosensitive image recording composition disclosed in the invention can be selected from one or two of the infrared absorbers sold on the market. To avoid the formation of sludge in a developer, infrared absorber that can be dissolved in the developer is preferable. The amount of infrared absorber preferably accounts for 1.0˜6.0 wt % of the total solid image recording composition.

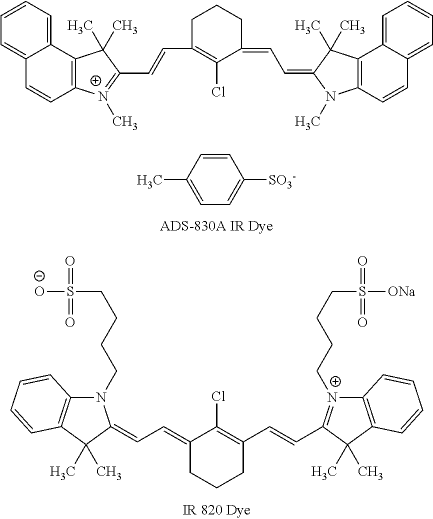

### 3. Surfactant

The surfactant used in the thermosensitive CTP image recording composition of the invention falls into two categories: surfactant used to improve the imageability and surfactant used to improve the performance of the coating area.

The surfactant used to improve the imageability includes nonionic surfactant, amphoteric surfactant, siloxane compound surfactant, surfactant formed by the polymerization of the fluorine-containing monomer. The nonionic surfactant includes sorbitan tri-stearate, sorbitan mono-palmitate, sorbitan tri-oleate, monoglycerol stearate, polyvinyl fluoride nonyl phenyl ether, etc., specifically, such as alkyl bis(aminoethyl)glycine and alkyl glycine ethyl salt. Siloxane surfactant, is preferably block polymer of dimethyl siloxane and polyalkylene oxide, such as DBE-224, DBE-621, DBE-712, DBP-732, DBP-534, Tego Glide 100 and other denatured silicone of polyalkylene oxide. Polymer surfactant based on fluoride monomer, is such as fluorine-containing acrylic polymer disclosed in gazette JP11-288063 and fluorine-containing polymer obtained through copolymerization of fluorine-containing acrylic monomer disclosed in gazette JP2000-187318 with any acrylic monomer. It is preferable to use fluorine-containing polymer with a weight average molecular of more than 2000 and number average molecular of more than 1000. It is more preferable to use fluorine-containing polymer with a weight average molecular of 5000-300000 and number average molecular of 2000-250000. The surfactant used to improve the imageability is preferably the fluorine-containing surfactant, such as (MEGAFAC) MCF312 manufactured by Dainippon Ink and Chemicals Incorporated.

To improve the imageability of the image recording composition and the performance of the coating area, two kinds of surfactants can be used at the same time. The amount of the two kinds of surfactants accounts for 0.05˜15 wt % of the total solid amount, more preferably 0.5˜5 wt %.

### 4. Developing Accelerator

Developing accelerator is the compound that exists in exposure area and is easily dissolved in an alkali developing solvent. It is selected from compounds that are easily self-dissolved in an alkali developing solvent or from polymers that accelerate the developing process.

The compounds that are easily self-dissolved in an alkali developing solvents refer to compounds containing acid group, such as sulfonic acid group, carboxylic acid group, phenolic hydroxyl group, phosphoric acid group. The compounds containing sulfonic acid group, carboxylic acid group, phenolic hydroxyl group, phosphoric acid group can accelerate the developing process and improve the sensibility. In U.S. Pat. No. 4,933,682, toluene sulfonic acid, naphthalene sulfonic acid and other aromatic sulfonic acid have been disclosed. In U.S. Pat. No. 4,115,128, cyclic anhydride such as phthalic acid anhydride, tetrahydro phthalic anhydride, hexahydro phthalic anhydride, 3,6-endoxy-Δ4-tetrahydrophthalic anhydride, maleic anhydride, chloro maleic anhydride, α-phenyl maleic anhydride, succinic acid anhydride, pyromellitic acid anhydride have been disclosed. Phenols include Bisphenol A, p-nitrophenol, p-ethoxy phenol, 2,4,4′-dihydroxybenzophenone, 4-hydroxybenzophenone, 4,4′,4″-trihydroxytriphenylmethane, 4,4′,3″,4″-tetrahydroxy-3,5,3′,5′-tetramethyl-triphenyl methane, etc.; organic acids include sulfonic acids, sulfinic acids, alkyl sulfonic acids, phosphoric acids, phosphate and carboxylic acids, such as p-toluenesulfonic acid, dodecylbenzene sulfonic acid, p-toluene sulfinic acid, ethyl sulfonic acid, phenyl phosphoric acid, phenyl-hypophosphorous acid, phenyl phosphate, diphenyl phosphate, benzoic acid, 4-cyclohexene-1,2-dicarboxylic acid, sinapic acid, lauric acid, ascorbic acid, 3,4,5-trimethoxy-benzoic acid, 3,4-dimethoxy-benzoic acid, phthalic acid, lauric acid, etc., the preferable amount thereof is 0.10˜10 wt %.

Developing accelerator polymer refers to phenolic resin of low polymerization degree and supramolecular compound with high alkali solubility. The phenolic resins of low polymerization degree on the market include DURITE SD126A, DURITE PD427A, DURITE PD390, DURITE PL1526 (from Bordenchem. INC); ALNOVOL SPN560, ALNOVOL SPN564, ALNOVOL SPN564 (from Clariant Gmbh.), HRJ 2606 (from Schnectady international Inc.), AV LITE resin SP1006N, AV LITE resin PAPS-PN1, AV LITE resin PAPS-PN2, AV LITE resin PAPS-PN3 (from SIEBER HEGNER). US2005136356 holds that developing accelerator polymer can improve the sensibility while at the same time maintain unexposed meshes and erosion resistance.

The developing accelerator in the invention accounts for 0.05˜20 wt % of the total solid composition, preferably 0.1˜15 wt % and more preferably 0.5˜3 wt %.

### 5. Colorant

Colorant helps to obtain a clear printing image. Ethyl Violet, methyl violet (C142535), crystal violet (C142555), malachite green (C142000), vat brilliant green 3B, Victoria blue B, Victoria blue R, Victoria blue 130, Victoria pure blue, flexblau 630 (from BASF), Basonyl blau 640 (from BASF), Basonyl Violet 610, as well as oil yellow # 101, oil yellow # 103, oil red # 312, oil green BG, oil blue BOS, oil blue # 603, oil Black BY, oil Black BS, oil black T-505, Rhodamine B (C1145170B), methylene blue (C152015), etc. are disclosed in JPA53-36223, JPA54-74728, JPA60-3626, JPA61-143748, JPA61-151644, JPA63-58440 etc.

These colorants account for 0.01˜10 wt % of the total solid image recording composition and preferably 0.1˜5 wt %, which is helpful to adjusting the color of the imaging layer, and distinguishing the imaging and non-imaging areas during the process.

### 6. Solvent

The image recording composition disclosed in the invention needs to be dissolved in a suitable solvent and then can be applied to the substrate to form a printing plate. The solvents include but not limit to ethylene dichloride, cyclohexanone, methyl ethyl ketone, methanol, ethanol, propanol, ethylene glycol monoethyl ether, 1-methoxy-2-propanol, 2-methoxy ethyl acetate, 1-methoxy-2-n-propyl acetate, dimethoxy ethane, methyl lactate, ethyl lactate, N,N-dimethylacetamide, N,N-dimethylformamide, tetramethylurea, N-methylpyrrolidone, dimethyl sulfoxide, sulfoalkyl, γ-butyrolactone, toluene, etc. These solvents can be used alone or in combination.

Said solvents account for 60˜97 wt % of the total image recording composition, preferably 70˜97 wt % and more preferably 75˜95 wt %.

In addition, after applied and dried, the coating amount of the image recording composition (solid composition) on the substrate is 0.5˜3.0 g/m², preferably 1.2˜2.5 g/m². When the coating amount on the thermosensitive layer is below 0.5 g/m², the film-forming properties and the imaging properties are reduced and when it is over 3.0 g/m², the sensitivity may be reduced. The coating methods include various methods such as rod coating, rotary coating, spray coating, curtain coating, dip coating, air knife coating, plate coating, rolling coating, etc.

### 7. Substrate Preparation

The substrate used in the invention requires necessary intensity, durability, and plate-like object, polyester film and aluminum sheets with a constant size are preferable, and more preferably are aluminum sheets specially used for making printing plates, with a thickness of 0.1˜0.6 mm, and preferably 0.15˜0.4 mm. The following treatments are required: (a) corrosion treatment with alkaline agents; (b) decontamination treatment; (c) surface roughening treatment; (d) alkali corrosion treatment; (e) anodization treatment; (f) surface pore sealing treatment.

Prior to the formation of a rough surface on the aluminum sheets, degreasing treatment with surfactant, organic solvent or alkaline aqueous solution is required. There are various methods to roughen the aluminum surface, such as mechanical roughening and electrochemical roughening. Mechanical roughening includes ball grinding, brush grinding, sand blasting grinding, polishing grinding and other known methods. Electrochemical roughening refers to surface roughening treatment in hydrochloric acid or nitrate electrolyte with alternating or direct current. It is also possible to combine these two methods. JP54-63902 disclosed such a combination. The aluminum sheets treated in such way require further anodization treatment after decontamination treatment and alkali corrosion treatment so as to enhance surface water retention and durability. Porous oxide film can be formed during anodization treatment of aluminum sheets. Electrolyte is usually sulfuric acid, phosphoric acid, oxalic acid, chromic acid or mixtures of these acids. The concentration of the electrolytes can be determined by the type of the electrolyte.

The condition of the anodization treatment depends on the used electrolyte. The electrolyte is usually a solution with a concentration of 1-80 wt %, liquid temperature of 5˜70, current strength of 5˜60 A/dm², voltage of 1˜100V, electrolysis time of 10 seconds ˜5 minutes. When the amount of anode oxide film is less than 1.0 g/m², the printability becomes insufficient and non-image areas become susceptible to damage, which can be easily adhered to printing ink during the printing process, resulting in “damage pollution”.

After anodization treatment, hydrophilic treatment to the surface of aluminum substrate is required. There are various hydrophilic treatments available, such as immersion treatments in sodium silicate aqueous solution or electrolytic treatment as disclosed in U.S. Pat. No. 2,714,066, U.S. Pat. No. 3,181,461, U.S. Pat. No. 3,280,734 and U.S. Pat. No. 3,902,734. The use of zirconium potassium fluoride is disclosed in JP36-22063 and treatment with polyethylene phosphate is disclosed in U.S. Pat. No. 3,276,868, U.S. Pat. No. 4,153,461, U.S. Pat. No. 4,689,272B.

The radiation used in exposure is infrared light source with a wavelength ranging from near-infrared to infrared. After the exposure with infrared radiation, developing treatment is required. The alkaline developer and “silicate developer” containing organic compounds that have buffer effect as main composition are used in the invention, with PH preferably ranging 12.5˜13.5 damage can be reduced, and defect-free image as well as good lithographic printing plate can be obtained.

The alkalis used in the developer in the invention include inorganic alkalis, like sodium metasilicate, sodium hydroxide, potassium hydroxide, lithium hydroxide, trisodium phosphate, tripotassium phosphate, triammonium phosphate, disodium phosphate, dipotassium phosphate, diammonium phosphate, sodium carbonate, potassium carbonate, ammonium carbonate, sodium bicarbonate, potassium bicarbonate, ammonium bicarbonate, sodium borate, potassium borate, ammonium borate, potassium citrate, tripotassium citrate, sodium citrate, and etc., or organic alkalis, like mono-methylamine, dimethyl amine, trimethylamine, mono-ethylamine, diethylamine, triethylamine, mono-isopropylamine, diisopropylamine, triisopropylamine, n-butylamine, monoethanolamine, diethanolamine, triethanolamine, monoisopropanolamine, diisopropanolamine, ethylenimine, ethylene diamine, pyridine and etc. These alkaline agents can be used alone or in combination. The inorganic alkalis are selected preferably from sodium metasilicate, sodium hydroxide and potassium hydroxide.

The alkali-soluble polymer used in the thermosensitive CTP plate image recording composition in the invention is obtained by chemical synthesis. The usual practice is that diphenol or p-aminophenol is reacted with various isocyanates or isothiocyanates to obtain compounds containing phenolic hydroxyl group, and carbamate or thiocarbamate group that has strong electron-absorbing ability, and then a condensation reaction with a variety of substituted phenols is carried out to obtain polymer containing phenolic hydroxyl group, and carbamate or thiocarbamate group that has strong electron-absorbing ability; or a partial chemical modificationon phenolic resin is carried out directly with various isocyanates or isothiocyanates so that the polymer molecules contain a part of phenolic hydroxyl group, and carbamate or thiocarbamate group.

After exposure and development for the thermosensitive CTP plate disclosed in this invention, a directly-to-printing CTP plate can be obtained.

### EXAMPLES

The following examples illustrate the invention in more details.

1. Preparation of the Substrates

The following treatments are applied to aluminum substrates used specially for printing plates.

(1) Degreasing Treatment with Alkaline Agent

The aluminum sheet was sprayed with aqueous solution containing 3.6 wt % sodium hydroxide, 1.5 wt % aluminum ion at a temperature of 60, and it was dissolved and corroded by 6 g/m². Then, the sheet was rinsed with water

(2) Electrochemical Roughening Treatment

1 wt % hydrochloric acid electrolyte (containing 0.5 wt % aluminum ion) at a temperature of 30, 50 Hz AC voltage, peak current density of 30 A/dm², total power consumption of 130 c/dm² were applied for a continuous electrochemical roughening treatment. Then, the sheet was rinsed with water.

(3) Decontamination Treatment with Alkali Corrosion

The aluminum sheet was sprayed and corroded with an aqueous solution containing 2 wt % sodium hydroxide, 0.5 wt % aluminum ion at a temperature of 32, and it was dissolved by 0.20 g/m². The aluminum hydroxide as the main dirt component produced during the previous electrochemical roughening treatment was removed. The rough edge portion was dissolved and a smooth edge portion was formed. Then, the sheet was rinsed with water.

(4) Anodization Treatment

17 wt % sulfuric acid (containing 0.5 wt % aluminum ion) was used as electrolyte at a temperature of 35. Under 30V DC, the oxide film ultimately formed is 3 g/m².

(5) Alkali Metal Silicate Treatment

The anodized aluminum substrate was immersed in 1.5 wt % sodium silicate solution (modulus number of 3) at a temperature of 30 for 30 seconds to carry out the alkali metal silicate treatment. Then, a spray with water is performed.

2. Synthesis of Alkali-Soluble Polymer

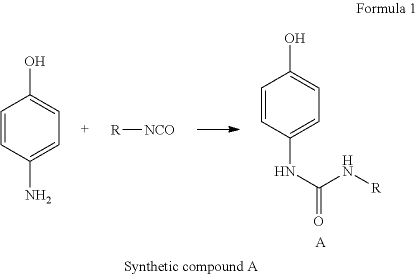

The reaction was carried out in an airtight ventilating cabinet. 160 ml waterless acetone and 0.544 mol (60 g) of p-aminophenol were added into a 1000 ml 3-neck round flask equipped with mechanical stirring, nitrogen inlet, thermometer, reflux condenser and constant pressure funnel. The solution of 0.53 mol p-toluene isocyanate in 500 ml acetone was added dropwise at a speed of 3˜4 ml/min at room temperature under nitrogen protection with stirring. After the addition was finished, the stirring was continued overnight. After the mixture was rotary evaporated until semi-dry, the concentrate was filtered and substances insoluble in acetone were removed. The filtrate was poured into 1000 ml distilled water, the precipitate was filtered, and washed with distilled water, and after vacuum drying, 96 g 1-(4-p-tolyl)-3-(4-hydroxyphenyl)urea crystal was obtained.

Except for that toluene isocyanate was substituted with phenyl isocyanate, isopropyl isocyanate, α-naphthyl isocyanate, other conditions remained the same and substituted ureas were obtained with different yields.

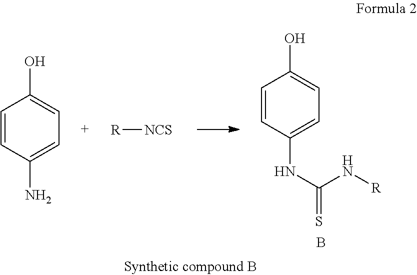

The reaction was carried out in an airtight ventilating cabinet. 200 ml waterless N,N-dimethylacetamide and 0.56 mol (61 g)ₚ-aminophenol were added into a 500 ml dry 3-neck flask equipped with mechanical stirring and constant pressure funnel. The solution of 0.55 mol (87.5 g) p-toluene isothiocyanatein 170 ml N,N-dimethylacetamide was added at a speed of 3˜4 ml/min at room temperature under nitrogen protection with stirring. After the addition was finished, the stirring was continued overnight. After the mixture was rotary evaporated until semi-dry, it was poured into 1000 ml distilled water, the precipitate was filtered, washed with distilled water, and vacuum dried, 101 g 1-(4-tolyl)-3-(4-hydroxyphenyl) thiourea was obtained. Except for that toluene isothiocyanate was substituted with phenyl isothiocyanate, α-naphthyl isothiocyanate, cyclohexyl isothiocyanate, the others remained the same. The substituted ureas were obtained with different yields.

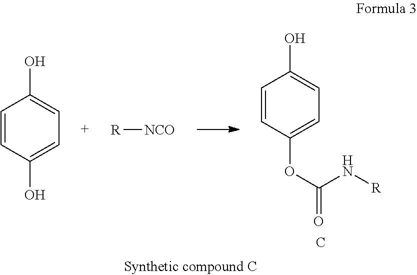

p-aminophenol was substituted with 1,4-hydroquinone. The others remained the same as in the reaction of p-aminophenol and R—NCO. Compound C was obtained.

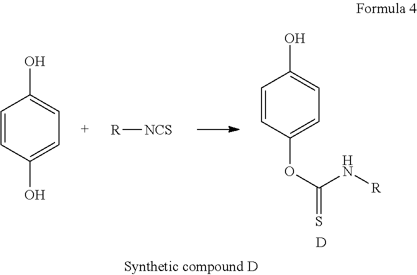

p-aminophenol was substituted with 1,4-hydroquinone. The others remained the same as in the reaction of p-aminophenol and R—NCS. Compound D was obtained.

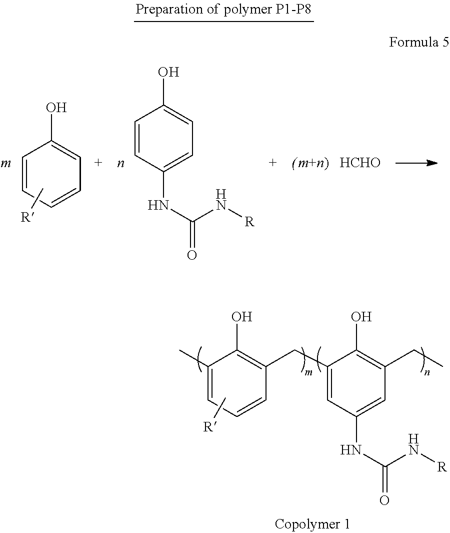

Phenol and 1-(4-tolyl)-3-(4-hydroxyphenyl)urea were added into a 3-neck flask. Formaldehyde aqueous solution was added in an amount of 95% of the total molar of the two phenols. Then oxalic acid was added as a catalyst. The pH value of the reaction system was adjusted to 3-5. Stirring was started and the temperature was raised to 90˜95 and refluxing was kept for 6 hours. After the distillation for 2 hours at 110, the temperature was raised gradually up to 180 for vacuum distillation. The product was poured out, and light-yellow polymer powder P1 that contains phenolic hydroxyl group and carbamate group was obtained after cooling and grinding. The proportion of n and m was changed to obtain polymer powders P2, P3, P4. The molecular weight and conversion rate of P1, P2, P3, and P4 are as follows

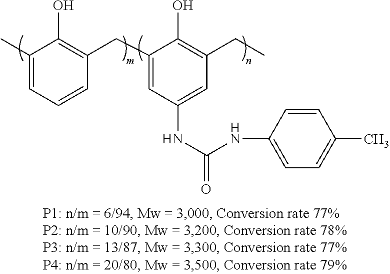

Except for that phenol was substituted with m-isopropyl-phenol, others remained the same. The light-yellow polymer powders P5, P6, P7, and P8 were obtained.

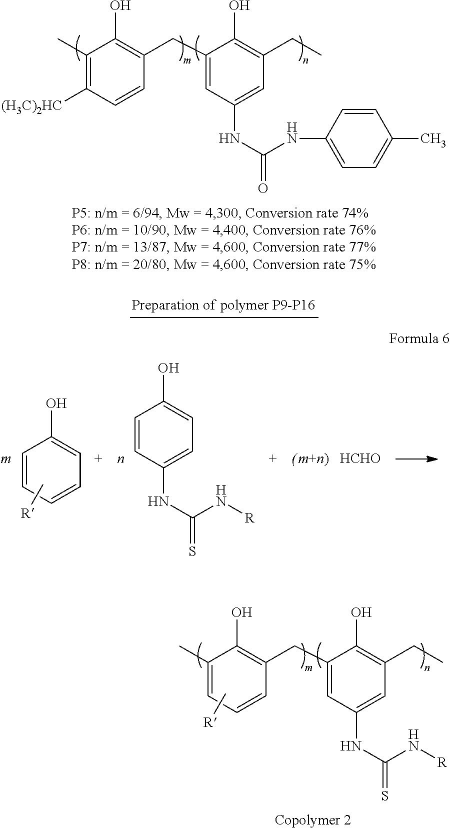

p-tert-butylphenol and 1-(4-tolyl)-3-(4-hydroxyphenyl)urea were added to a 3-neck flask. Formaldehyde aqueous solution was added in an amount of 90% of the total molar of the two phenols. Then oxalic acid was added as a catalyst. pH value of the reaction system was adjusted to 3˜5. Stirring was started, and the temperature was raised to 85˜90 and refluxing was kept for 5 hours. After Distillation for 2 hours at 110, the temperature was gradually raised up to 190 for vacuum distillation. The product was poured out and polymer P9 was obtained after cooling and grinding. The proportion of n and m was changed to obtain polymer P10, P11, P12. The molecular weight and conversion rate of P9, P10, P11, and P12 are as follows.

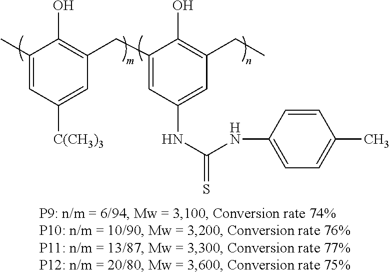

Except for that p-tert-butylphenol was substituted with m-methylphenol, the others remained the same. Polymers P13, P14, P15, P16 were obtained. The molecular weight and conversion rate of P13, P14, P15, and P16 are as follows.

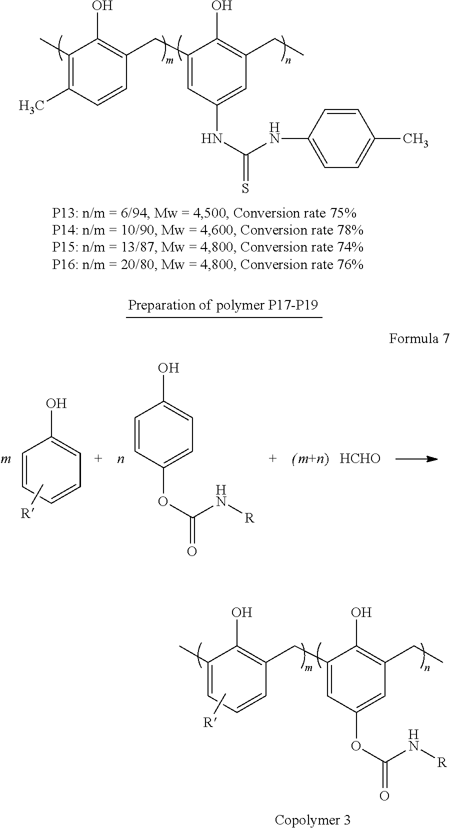

m-phenol and p-hydroxy phenyl N-(α-naphthyl) carbamate were added to a 3-neck flask. Formaldehyde aqueous solution was added in an amount of 90% of the total molar of the two phenols. Then oxalic acid was added as a catalyst. pH value of the reaction system was adjusted to 3˜5. Stirring was started, and the temperature was raised to 90˜95 and refluxing was kept for 8 hours. After the Distillation for 2 hours at 110, the temperature was gradually raised up to 170 for vacuum distillation. The product was poured and polymer powders P17, P18, P19 were obtained after cooling and grinding. The molecular weight and conversion rate of P17, P18 and P19 are as follows.

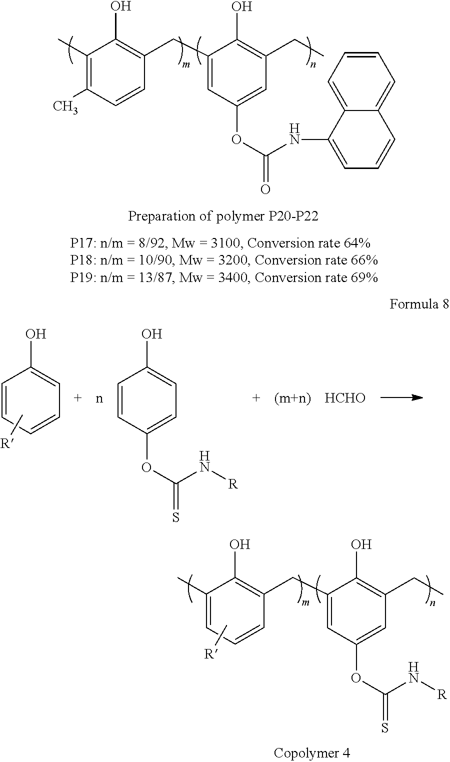

p-cresol and p-hydroxyphenyl N-cyclohexyl thiocarbamate were added to a 3-neck flask. Formaldehyde aqueous solution was added in an amount of 90% of the total molar of the two phenols. Then oxalic acid was added as a catalyst. pH value of the reaction system was adjusted to 3˜5. Stirring was started, and the temperature was raised to 90˜95 and refluxing was kept for 8 hours. After the Distillation for 2 hours at 110, the temperature was raised gradually up to 170 for vacuum distillation. The product was poured out and polymer powders P20, P21, P22 were obtained after cooling and grinding. The molecular weight and conversion rate of P20, P21 and P22 are as follows.

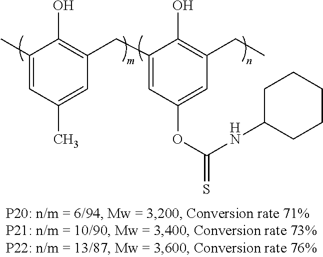

Novolak phenolic resin partial modified with different isocyanate

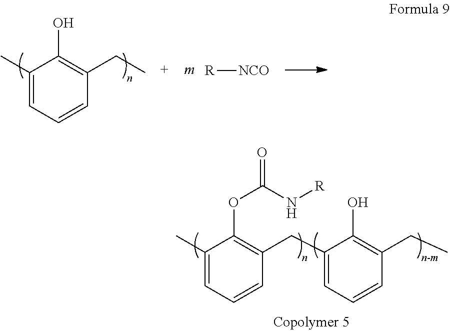

The reaction was carried out in an airtight ventilating cabinet. 150 ml waterless CHCl₃, 1 mol (60 g) Bakelite 6564LB phenolic resin (from Bakelite AG, Germany, Mw=5000) and 5 g triethylamine were added into a 500 ml dry 3-neck flask equipped with mechanical stirring and constant pressure funnel. 170 ml CHCl₃ solution containing 0.10 mol p-toluene isocyanate was added dropwise at a speed of 3˜4 ml/min with stirring under the nitrogen protection at room temperature. After the addition was finished, the stirring was kept overnight. The mixture was rotary evaporated until semi-dry. The mixture was poured into 1000 ml ice water, and the precipitate was filtered, washed with distilled water, vacuum dried, and p-toluene isocyanate partially modified polymer P23 was obtained. The carbamate group accounts for 9% of molar percentage of unmodified phenolic hydroxyl. Except for that toluene isocyanate was substituted with phenyl isocyanate, α-naphthyl isocyanate, cyclohexyl isocyanate, isopropyl isocyanate, the others remained the same. The polymers P24, P25, P26, P27 were obtained.

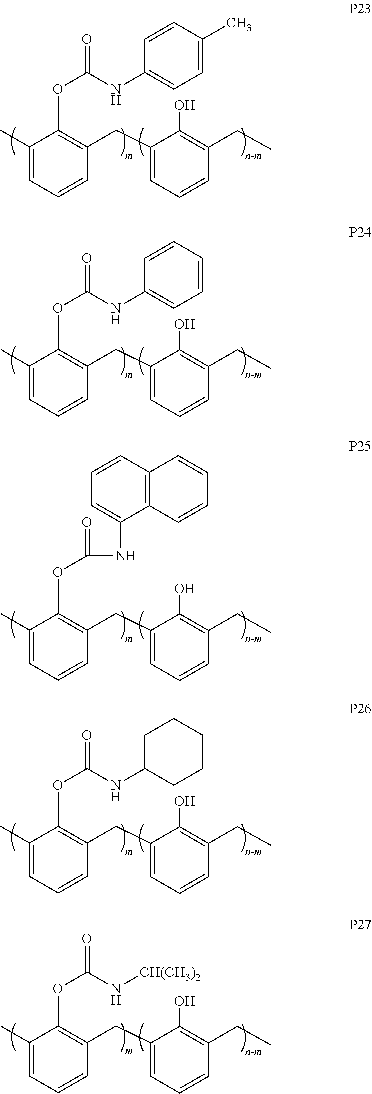

Novolak phenolic resin partial modified with isothiocyanate

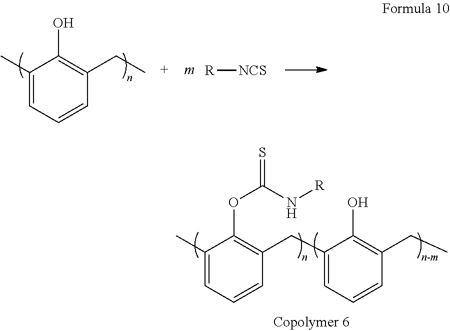

Phenyl isothiocyanate, cyclohexyl isothiocyanate were reacted respectively with Bakelite 6564LB phenolic resin (from Bakelite AG, Germany, Mw=5000). The operation was similar to the reaction of phenolic resin partial modified with isocyanate. Polyers P28 and P29 were obtained.

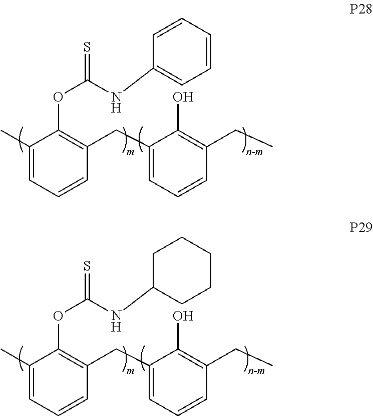

3. Preparation of Positive Thermosensitive CTP Original Plate and the Evaluation

### Example 1-7

The substrate was coated with a coating amount of 1.6 g/cm² with thermosensitive positive image recording composition: 22.52 g polymer P1 (or P9, or P18, or P20, or P23, or P25 or P29), 0.71 g IR830A infrared absorber, 250 g mixed solvent of γ-butyrolactone/acetone/isobutyl ketone=150/200/650. The coated sample plate was then dried in an oven at 120 for 10 minutes and the thermosensitive positive CTP original plate was obtained.

The obtained CTP original plate was exposed in a Creo Trendsetter 800 Quantum with a laser of 830 nm and laser power of 8 W at a drum rotation speed of 158 rpm. The plate was then developed in Xingraphics DV-F3 developer (from Chengdu Xingraphics Co., Ltd.) at 25 for 40 seconds. The exposed areas of the original plate were completely dissolved while the non-exposed areas were not dissolved. The developed plate demonstrated a clear image with a sharp and trimmed edge.

### Comparative Example 1

The substrate was coated with a coating amount of 1.6 g/cm² with thermosensitive positive image recording composition: 22.53 g Bakelite 6564LB phenolic resin (from Bakelite AG, Germany, Mw=5000), 0.71 g IR830A infrared absorber, 250 g mixed solvent of γ-butyrolactone/acetone/isobutyl ketone=150/200/650. The coated sample plate was then dried in an oven at 120 for 10 minutes and the thermosensitive positive CTP original plate was obtained.

The obtained original plate was exposed and developed as in the example 1. The exposed and non-exposed areas were all dissolved in the developer within less than 6 seconds. No image was obtained.

### Example 8-14

Except for that 0.7 g IR830A infrared absorber in example 1 was changed to 1.0 g 3˜10 μm carbon black, the rest of the operation was the same. The results similar to that of example 1-7 were obtained.

### Comparative Example 2

Except for that 0.7 g IR830A infrared absorber in comparative example 1 was changed to 1.0 g 3˜10 μm carbon black, the rest of the operation was the same. The exposed and non-exposed areas were all dissolved in the developer within less than 5 seconds. No image was obtained.

The aforementioned examples and comparative examples demonstrated that the alkali-soluble resin that contains phenolic hydroxyl group, and carbamate or thiocarbamate group that has strong electron-absorbing ability has both bonding and self dissolution inhibiting properties. The CTP original plate coated with the composition of these polymers and infrared absorber can be exposed by 830 nm infrared laser to obtain images. However, the CTP original plate coated with the composition of Bakelite 6564LB phenolic resin and infrared absorber used in comparative examples cannot obtain images after being exposed by 830 nm infrared laser. The exposed and non-exposed areas were all dissolved in the developer.

### Example 15-22

The substrate was coated with a coating amount of 1.6 g/cm² with thermosensitive positive image recording composition: 19.80 g polymer P1, 0.55 g IR830A infrared absorber, 0.40 g MCF312 surfactant, 0.15 g F-176 surfactant, 1.00 g crystal violet lactone, 0.75 g phthalic anhydride were dissolved in 250 g mixed solvent of γ-butyrolactone/acetone/isobutyl ketone=150/200/650. The coated sample plate was then dried in an oven at 120 for 10 minutes and the thermosensitive positive CTP original plate was obtained.

The obtained CTP original plate was exposed in a Creo Trendsetter 800 Quantum with a laser of 830 nm and laser power of 8 W at a drum rotation speed of 158 rpm. The plate was then developed in Xingraphics DV-F3 developer at 25.

P1 in example 1 was respectively substituted with P10, P18, P21, P23, P24, P28 and P29 and the other components remain unchanged. The data of imaging energy were shown in table 1.

TABLE 1
Imaging energy required by different coating liquids

| | Example | | | | | | | |
|---|---|---|---|---|---|---|---|---|
| | Example | Example | Example | Example | Example | Example | Example | Example |
| | 15 | 16 | 17 | 18 | 19 | 20 | 21 | 22 |
| Polymer | P1 | P10 | P18 | P21 | P23 | P24 | P28 | P29 |
| Imaging | 100 | 130 | 110 | 120 | 130 | 120 | 90 | 110 |
| Energy | | | | | | | | |
| (mJ/cm²) | | | | | | | | |
| Clearness | Clear | Clear | Clear | Clear | Clear | Clear | Clear | Clear |

### Example 23-30

The substrate was coated with a coating amount of 1.6 g/cm² with thermosensitive positive image recording composition: 19.82 g polymer P1, 0.54 g IR830A infrared absorber, 0.42 g MCF312 surfactant, 0.14 g F-176 surfactant, 0.95 g crystal violet lactone, 0.75 g phthalic anhydride were dissolved in 250 g mixed solvent of γ-butyrolactone/acetone/isobutyl ketone=150/200/650. The coated sample plate was then dried in an oven at 120 for 10 minutes and the thermosensitive positive CTP original plate was obtained.

The obtained CTP original plate was exposed in a Creo Trendsetter 800 Quantum with a laser of 830 nm and laser power of 8 W at a drum rotation speed of 158 rpm. The plate was then developed in Xingraphics DV-F3 developer at 25. The time that exposed areas and more than 80% of non-exposed areas were dissolved completely has been recorded respectively.

P1 in example 23 was respectively substituted with P2, P3, P4, P5, P6, P7 and P8 and the other components remain unchanged. The data of dissolution time were shown in table 2.

TABLE 2
Dissolution time of exposed and non-exposed areas

| | Example | | | | | | | |
|---|---|---|---|---|---|---|---|---|
| | Example | Example | Example | Example | Example | Example | Example | Example |
| | 23 | 24 | 25 | 26 | 27 | 28 | 29 | 30 |
| Polymer | P1 | P2 | P3 | P4 | P5 | P6 | P7 | P8 |
| Dissolution | 10 | 15 | 30 | 58 | 15 | 25 | 50 | 55 |
| time of | | | | | | | | |
| exposed | | | | | | | | |
| areas (s) | | | | | | | | |
| Dissolution | 153 | 218 | 265 | 465 | 145 | 205 | 245 | 455 |
| time of | | | | | | | | |
| non-exposed | | | | | | | | |
| areas (s) | | | | | | | | |

The time needed to dissolve the exposed areas is far less than that to dissolve non-exposed areas. As n/m ratio in copolymer is increasing, the time needed to dissolve the non-exposed areas is increasing (more than 2.5 minutes on average) while the time needed to dissolve the exposed areas is substantially within 1 minute.

1. A positive-working thermosensitive lithographic printing plate,
characterized in that it consists essentially of a hydrophilic substrate and a layer of thermosensitive image recording composition applied on the hydrophilic substrate, and said composition comprises:
(A) a resin having a self-dissolution inhibiting ability; and
(B) an infrared absorber.

2. The printing plate according to claim 1, wherein said resin is an alkali-soluble resin that contains phenolic hydroxyl group, and carbamate, thiocarbamate, ureido or thioureido group that has strong electron-absorbing ability and the resin is shown as formulas I and II: 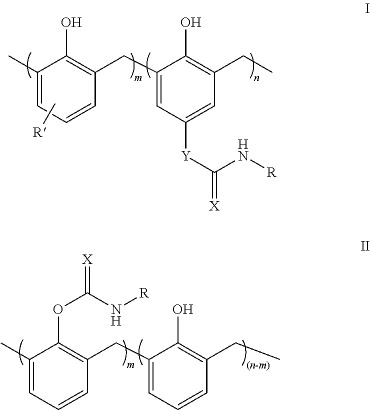
in which, X═O or S; Y═O or N; R=phenyl, p-tolyl, isopropyl, 1-naphthyl, o-tolyl, or cyclohexyl;
R′=hydrogen or alkyl; in Formula I, m/(m+n)=0.05˜0.8; in Formula II, m/n=0.05˜0.7.

3. The printing plate according to claim 1, wherein the infrared absorber absorbs infrared light with a wavelength between 750 nm and 1200 nm.

4. The printing plate according to claim 1, wherein the infrared absorber is at least one selected from the group consisting of cyanine dye, anthraquinone dye, phthalocyanine dye, quinone imine dye, and methine dye.

5. The printing plate according to claim 1, wherein the resin accounts for 55˜95 wt % of the total solid weight of the image recording composition.

6. The printing plate according to claim 1, wherein the infrared absorber accounts for 1.0˜6 wt % of the total solid weight of the image recording composition.

7. The printing plate according to claim 1, wherein the hydrophilic substrate is aluminum substrate.
